(19) United States
(12) Patent Application Publication
(10) Pub. No.: US 2026/0233399 A1
(43) Pub. Date: Aug. 13, 2026

(54) ROBOT CONTROL DEVICE, ROBOT SYSTEM, AND ROBOT CONTROL PROGRAM

(71) Applicant: FANUC CORPORATION, Minamitsuru-gun, Yamanashi (JP)

(72) Inventor: Kentaro KOGA, Minamitsuru-gun, Yamanashi (JP)

(73) Assignee: FANUC CORPORATION, Minamitsuru-gun, Yamanashi (JP)

(21) Appl. No.: 19/155,623

(22) PCT Filed: Mar. 3, 2023
(86) PCT No.: PCT/JP2023/008141

§ 371 Date: Aug. 12, 2025

(51) Int. Cl. B25J 9/16; B25J 9/00; B65B 5/10

(52) U.S. Cl. CPC B25J 9/1679; B25J 9/0084; B25J 9/0093; B65B 5/105

(57) ABSTRACT

A robot control device includes a container supply quantity calculation unit, an article supply quantity calculation unit, and a temporary holding unit control information generation unit. The container supply quantity calculation unit calculates the quantity supplied of a plurality of the containers conveyed by the container conveying device, and the article supply quantity calculation unit calculates the quantity supplied of a plurality of the articles conveyed by the article conveying device. The temporary holding unit control information generation unit generates control information for a temporary holding unit having a temporary holding space for temporarily holding at least one article that can be moved by a predetermined amount in a first direction or a second direction opposite to the first direction, on the basis of the output from the container supply quantity calculation unit and the output from the article supply quantity calculation unit.

### CROSS REFERENCE TO RELATED APPLICATIONS

This is the U.S. National Phase application of PCT/JP2023/008141, filed Mar. 3, 2023, the disclosure of this application being incorporated herein by reference in its entirety for all purposes.

### FIELD OF THE INVENTION

The present disclosure relates to a robot controller, a robot system, and a robot control program.

### BACKGROUND OF THE INVENTION

In recent years, for example, a robot system for controlling a plurality of robots, taking out an article conveyed by an article conveyance conveyor while following the article, and packing (encasing) the article in a container (box) conveyed by a container conveyance conveyor while following the container is used in various fields.

In such a robot system, for example, when articles to be conveyed are oversupplied, the excessive article is provisionally withdrawn onto a temporary placement unit, and, when an oversupply of the articles is suppressed, the article on the temporary placement unit is packed in the container.

In the robot system for packing the article conveyed by the article conveyance device in the container conveyed by the container conveyance device, there have conventionally been various proposals to provisionally withdraw the oversupplied excessive article onto the temporary placement unit functioning as a buffer.

### PATENT LITERATURE

[PTL 1] Japanese Unexamined Patent Publication (Kokai) No. 2022-122313
[PTL 2] Japanese Unexamined Patent Publication (Kokai) No. 2018-001312

### SUMMARY OF THE INVENTION

As described above, the robot system in which the temporary placement unit functioning as the buffer is provided and, for example, in a case of an oversupply of articles to be conveyed, the excessive article is provisionally withdrawn onto the temporary placement unit has been conventionally known.

However, the conventional robot system including the temporary placement unit only merely provisionally withdraws an oversupplied excessive article onto the temporary placement unit, and cannot effectively use the temporary placement unit.

Thus, provision of a robot controller, a robot system, and a robot control program that can effectively use a temporary placement unit onto which an oversupplied excessive article is withdrawn is desired.

One embodiment according to the present disclosure provides a robot controller that controls a robot in such a way that the robot takes out an article conveyed by an article conveyance device while following the article, and packs the article in a container conveyed by a container conveyance device while following the container, and the robot controller includes a container supply amount calculation unit, an article supply amount calculation unit, and a temporary placement unit control information-generation unit.

The container supply amount calculation unit calculates a supply amount of a plurality of the containers conveyed by the container conveyance device, and the article supply amount calculation unit calculates a supply amount of a plurality of the articles conveyed by the article conveyance device. The temporary placement unit control information-generation unit generates control information about a temporary placement unit including a temporary placement space where at least one of the articles is temporarily placed and being movable by a predetermined amount in a first direction or a second direction opposite to the first direction, based on an output of the container supply amount calculation unit and an output of the article supply amount calculation unit.

### BRIEF DESCRIPTION OF DRAWINGS

FIG. 1 is a diagram schematically illustrating main units in one example of a robot system according to the present embodiment.

FIG. 2 is a diagram for describing processing of each robot in the one example of the robot system according to the present embodiment.

FIG. 3 is a functional block diagram for describing one example of a robot controller according to the present embodiment.

FIG. 4 is a flowchart for describing one example of processing in one example of a robot control program according to the present embodiment.

FIG. 5 is a flowchart (part 1) for describing one example of temporary placement unit control processing in the one example of the robot system according to the present embodiment.

FIG. 6 is a flowchart (part 2) for describing one example of the temporary placement unit control processing in the one example of the robot system according to the present embodiment.

FIG. 7 is a diagram for describing one example of first temporary placement processing in the flowcharts illustrated in FIGS. 5 and 6.

FIG. 8 is a diagram for describing one example of second temporary placement processing in the flowcharts illustrated in FIGS. 5 and 6.

FIG. 9 is a diagram for describing one example of third temporary placement processing in the flowcharts illustrated in FIGS. 5 and 6.

FIG. 10 is a diagram for describing one example of fourth temporary placement processing in the flowcharts illustrated in FIGS. 5 and 6.

FIG. 11 is a diagram for describing one example of fifth temporary placement processing in the flowcharts illustrated in FIGS. 5 and 6.

### DETAILED DESCRIPTION OF EMBODIMENTS OF THE INVENTION

Hereinafter, examples of a robot controller, a robot system, and a robot control program according to the present embodiment will be described in detail with reference to accompanying drawings. The same or similar element is denoted by the same or similar reference sign in each of the drawings. Further, an embodiment described below does not limit a technical scope of the invention described in claims and meaning of a term.

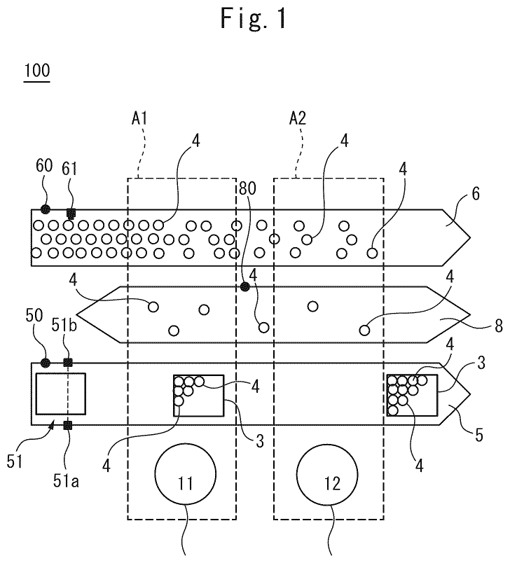

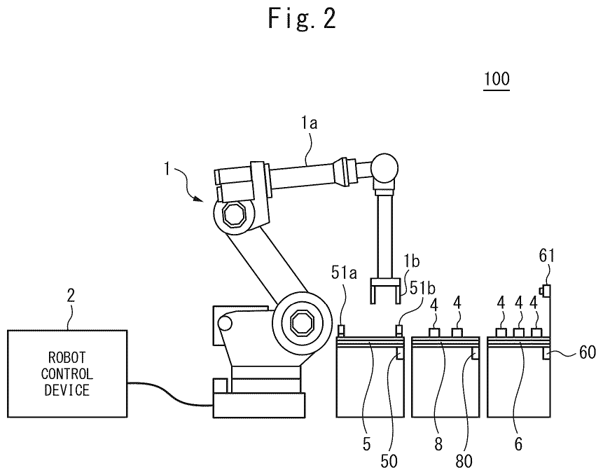

FIG. 1 is a diagram schematically illustrating main units in one example of the robot system according to the present embodiment, and FIG. 2 is a diagram for describing processing of each robot in the one example of the robot system according to the present embodiment. In FIGS. 1 and 2, reference signs 1, 11, and 12 indicate robots, a reference sign 2 indicates a robot controller, a reference sign 3 indicates a container, a reference sign 4 indicates an article, a reference sign 5 indicates a container conveyance conveyor (container conveyance device), and then a reference sign 6 indicates an article conveyance conveyor (article conveyance device).

Furthermore, a reference sign 8 indicates a temporary placement conveyor (temporary placement unit), a reference sign 100 indicates a robot system, and then reference signs A1 and A2 each indicate a region (work region) where work by the robots 11 and 12 can be performed. Herein, FIG. 1 illustrates only the two robots 11 and 12 for simplifying the description, but it is needless to say that the robot system 100 according to the present embodiment can include a greater number of the robots 1.

In the robot system 100 illustrated in FIG. 1, a movement belt of the container conveyance conveyor 5 and the article conveyance conveyor 6 moves, for example, from the left (upstream side) toward the right (downstream side) in the diagram. A movement belt of the temporary placement conveyor 8 is provided between the container conveyance conveyor 5 and the article conveyance conveyor 6, and can move in both directions from the left to the right and from the right to the left in the diagram. Herein the three conveyors 5, 8, and 6 are each disposed in parallel across the work region A1 of the robot 11 and the work region A2 of the robot 12. In other words, a part of each of the three conveyors 5, 8, and 6 is included in the work regions A1 and A2 of at least the two robots 11 and 12.

The container conveyance conveyor 5 is provided with an encoder (first encoder) 50 for calculating a movement amount (movement speed) in which the container 3 is conveyed, and a photoelectric sensor (position information acquisition sensor) 51 that detects passage of the container 3. The photoelectric sensor 51 includes a light receiving unit 51a and a light emitting unit 51b, and, when the container 3 comes between the light receiving unit 51a and the light emitting unit 51b, the light receiving unit 51a cannot receive light from the light emitting unit 51b, and position information about the container 3 is acquired from a timing at which the container 3 intercepts the light. Note that the photoelectric sensor 51 is not limited to a transmission photoelectric sensor as illustrated, and may be a retroreflection or diffuse reflection photoelectric sensor. Furthermore, the photoelectric sensor 51 is not limited to a photoelectric sensor, and other various sensors such as, for example, a visual sensor can also be applied as long as the sensor can detect the container 3 conveyed by the conveyor 5 and acquire position information.

The article conveyance conveyor 6 is provided with an encoder (second encoder) 60 for calculating a movement amount in which the article 4 is conveyed, and a camera 61 for detecting a state of the article 4 to be conveyed. The temporary placement conveyor 8 is also provided with an encoder (third encoder) 80 for calculating a movement amount and a movement direction in which the article 4 temporarily placed in a temporary placement space is conveyed. Note that the encoders 50, 60, and 80 do not necessarily need to be provided on the movement belt of the conveyor as long as movement information by each of the conveyors 5, 6, and 8 can be acquired, and can also be provided on, for example, a driving motor and the like in the conveyor. Furthermore, as the encoder, other various means can also be applied as long as the means can acquire movement information by the conveyor.

Herein, for example, in the work region Al of the first robot 11, the first robot 11 takes out the article 4 conveyed by the article conveyance conveyor 6 while following the article 4, and packs the article 4 that has been taken out in the container 3 conveyed by the container conveyance conveyor 5 while following the container 3. Similarly, for example, in the work region A2 of the second robot 12, the second robot 12 takes out the article 4 conveyed by the article conveyance conveyor 6 while following the article 4, and packs the article 4 that has been taken out in the container 3 conveyed by the container conveyance conveyor 5 while following the container 3.

At this time, a supply amount of the articles 4 may be excessive due to, for example, a slow movement speed of the container 3 by the container conveyance conveyor 5, a great number of the articles 4 conveyed (supplied) by the article conveyance conveyor 6, or other various factors. For example, when the number of the articles 4 supplied to the first robot 11 is excessive, or the container 3 has no space for the second robot 12 to pack the article 4, it is preferable that some of the articles 4 are taken out and provisionally placed (temporarily placed) in the temporary placement space (temporary placement conveyor 8). Conversely, for example, when the number of the articles 4 supplied to the first robot 11 is insufficient, or the container 3 has more than enough space for the second robot 12 to pack the article 4, it is preferable that the article 4 placed in the temporary placement space is used and the packing work continues.

In the robot system in the present example, the temporary placement space is formed by the temporary placement conveyor 8 that can move in both directions. Note that, in FIGS. 1 and 2, the temporary placement conveyor 8, the container conveyance conveyor 5, and the article conveyance conveyor 6 are each a line conveyor disposed in parallel, and the temporary placement conveyor 8 is provided between the container conveyance conveyor 5 and the article conveyance conveyor 6, but this configuration is merely one example. In other words, for example, the container conveyance conveyor 5 and the article conveyance conveyor 6 can be provided in parallel, and the temporary placement conveyor 8 can be three-dimensionally disposed in such a way as to cross the container conveyance conveyor 5 and the article conveyance conveyor 6 above or below the container conveyance conveyor 5 and the article conveyance conveyor 6. Note that a state of the article 4 (for example, the number and a placement place of the article 4) placed on the temporary placement conveyor 8 can be confirmed by recording, in advance, control information about the robot 1 (for example, position information about a grasping portion 1b by the robot controller 2) that places the article 4 on the temporary placement conveyor 8, and the like, for example. As a matter of course, a different camera from the camera 61 provided on the article conveyance conveyor 6 can be provided, for example, above the temporary placement conveyor 8 between the work regions A1 and A2, and the like, and directly detect a state of the article 4 temporarily placed on the temporary placement conveyor 8.

In this way, according to the robot system 100 in the present example, the temporary placement space is formed as the temporary placement conveyor 8 that can move in both directions instead of a fixed position, and thus the temporary placement space having a sufficient area can be secured. Furthermore, as described below in detail, the temporary placement space can be effectively used by appropriately processing the article 4 placed in the temporary placement space (temporary placement conveyor 8) by a plurality of robots (11, 12). For example, by executing processing in which the article 4 temporarily placed by a certain robot (11) is taken out and packed in the container 3 by another robot (12), excess and insufficiency of the article 4 in the work region (A1, A2) of each robot can be reduced. This also reduces stagnation of the article 4 in the temporary placement space, for example, when the article 4 being handled is fruit, fresh vegetables, and the like and is not thus desired to stagnate.

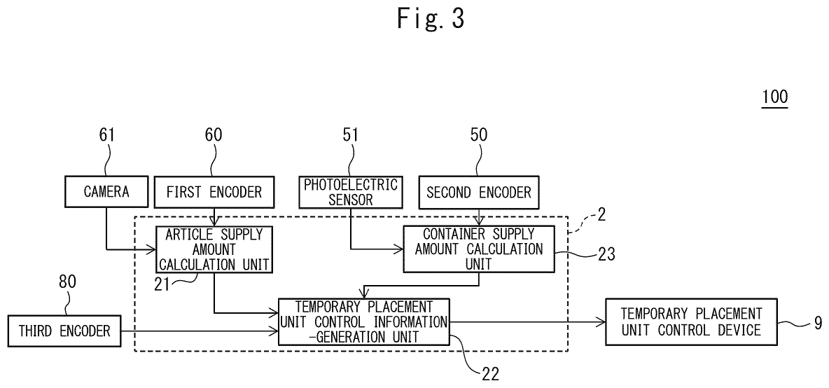

FIG. 3 is a functional block diagram for describing one example of the robot controller according to the present embodiment. The robot controller 2 in the present example controls the robot 1 in such a way that the robot 1 takes out the article 4 conveyed by the article conveyance conveyor 6 while following the article 4, and packs the article 4 in the container 3 conveyed by the container conveyance conveyor 5 while following the container 3. As illustrated in FIG. 3, the robot controller 2 includes an article supply amount calculation unit 21, a temporary placement unit control information-generation unit 22, and a container supply amount calculation unit 23.

The article supply amount calculation unit 21 receives an output of the second encoder 60 and the camera 61 provided on the article conveyance conveyor 6, and calculates a supply amount of the plurality of articles 4 conveyed by the article conveyance conveyor 6. Herein, the second encoder 60 is provided on the upstream side in the work region A1 of the first robot 1 illustrated in FIG. 1, for example, and acquires a movement amount (movement speed) of the article 4 conveyed by the article conveyance conveyor 6. Further, the camera 61 is also provided on the upstream side in the work region A1 of the first robot 1, for example, and acquires a state (a quantity, a position, and the like) of the article 4 conveyed by the article conveyance conveyor 6. By receiving an output of the second encoder 60 and the camera 61, the article supply amount calculation unit 21 can calculate a supply amount of the plurality of articles 4. Furthermore, the article supply amount calculation unit 21 can also calculate a current position of each of the articles 4 conveyed by the article conveyance conveyor 6.

The container supply amount calculation unit 23 receives an output of the first encoder 50 and the photoelectric sensor 51 provided on the container conveyance conveyor 5, and calculates a supply amount of the plurality of containers 3 conveyed by the container conveyance conveyor 5. Herein, the photoelectric sensor 51 is provided on the upstream side in the work region A1 of the first robot 1, and acquires position information about the container 3 from a timing at which the container 3 conveyed by the container conveyance conveyor 5 comes between the light receiving unit 51a and the light emitting unit 51b and the light receiving unit 51a cannot receive light from the light emitting unit 51b. Further, the first encoder 50 is also provided on the upstream side in the work region A1 of the first robot 1, and acquires a movement amount of the container 3 conveyed by the container conveyance conveyor 5. By receiving an output of the first encoder 50 and the photoelectric sensor 51, the container supply amount calculation unit 23 can calculate a supply amount of the plurality of containers 3. Furthermore, the container supply amount calculation unit 23 can also calculate a current position of the container 3 conveyed by the container conveyance conveyor 5.

The temporary placement unit control information-generation unit 22 moves, by a predetermined amount in a forward direction (first direction) or a reverse direction (second direction), a temporary placement space where at least one of the articles 4 is temporarily placed in the temporary placement conveyor (temporary placement unit) 8 including the temporary placement space, based on an output of the container supply amount calculation unit 23 and an output of the article supply amount calculation unit 21. Herein, an output of the third encoder 80 provided on the temporary placement conveyor 8 is input to the temporary placement unit control information-generation unit 22, and a movement direction and a movement speed of the temporary placement conveyor 8 can be confirmed. Note that, as described above, a state of the article 4 (for example, the number and a placement place of the article 4) temporarily placed on the temporary placement conveyor 8 (temporary placement space) can be confirmed from control information about a robot that places the article 4 on the temporary placement conveyor 8, a further output of a camera provided above the temporary placement conveyor 8 (temporary placement space), or the like. For example, an output of the temporary placement unit control information-generation unit 22 is input to a temporary placement unit control device 9 provided in a programmable logic controller (PLC) being a host control device of the plurality of robot controllers 2 that control the plurality of robots 1, and a movement direction and a movement amount of the temporary placement conveyor 8 are controlled. In other words, the PLC receives an output of the plurality of temporary placement unit control information-generation units 22 being output from the plurality of robot controllers 2, and executes processing of the article 4 placed on the temporary placement conveyor 8, which is suitable for each of the plurality of robots 1.

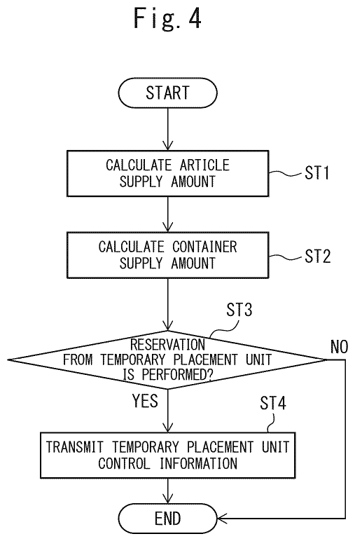

FIG. 4 is a flowchart for describing one example of processing in one example of the robot control program according to the present embodiment. As illustrated in FIG. 4, when the one example of the processing (temporary placement unit control information-generation processing) in the one example of the robot control program according to the present embodiment starts, an article supply amount is calculated in step ST1. In other words, the article supply amount calculation unit 21 calculates a supply amount of the plurality of articles 4 conveyed by the article conveyance conveyor 6, based on an output of the first encoder 60 and the camera 61 provided on the article conveyance conveyor 6.

Next, the processing proceeds to step ST2, and a container supply amount is calculated. In other words, the container supply amount calculation unit 23 calculates a supply amount of the plurality of containers 3 conveyed by the container conveyance conveyor 5, based on an output of the first encoder 50 and the photoelectric sensor 51 provided on the container conveyance conveyor 5. Furthermore, the processing proceeds to step ST3, and whether reservation from the temporary placement unit is performed, i.e., whether the article 4 is taken out from the temporary placement conveyor 8 or whether the article 4 is placed (temporarily placed) on the temporary placement conveyor 8 is determined.

In step ST3, when it is determined that the article 4 is reserved (YES), the processing proceeds to step ST4, and the temporary placement unit control information-generation unit 22 transmits temporary placement unit control information to the temporary placement unit control device 9, and, for example, the temporary placement unit control device 9 moves the temporary placement unit (temporary placement conveyor 8). In step ST3, when it is determined that the article 4 is not reserved (NO), the processing ends. Herein, in step ST3, a case where the article 4 is reserved (YES) is, for example, a case where a supply amount of the articles 4 is great and excessive, a case where a supply amount of the articles 4 is small and insufficient, or the like.

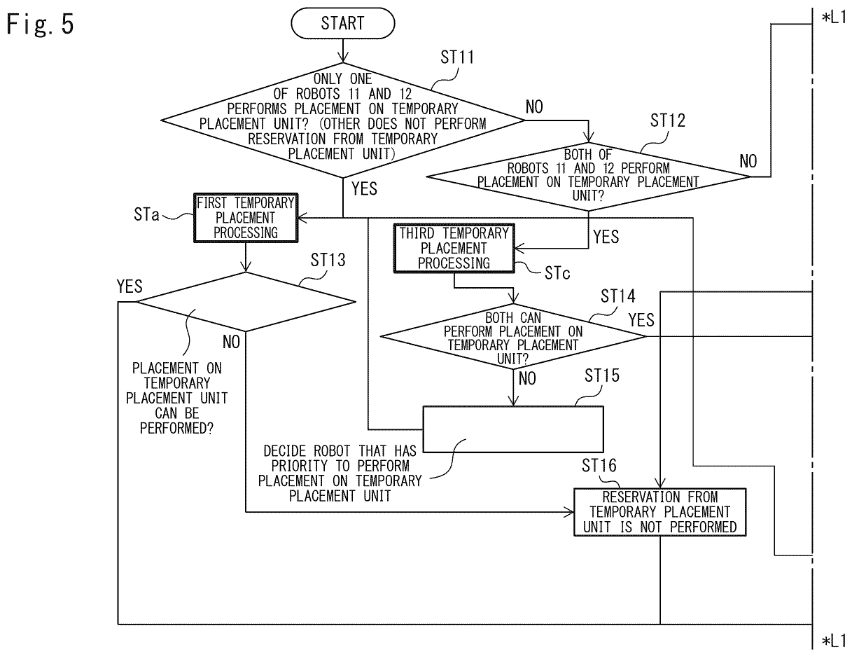

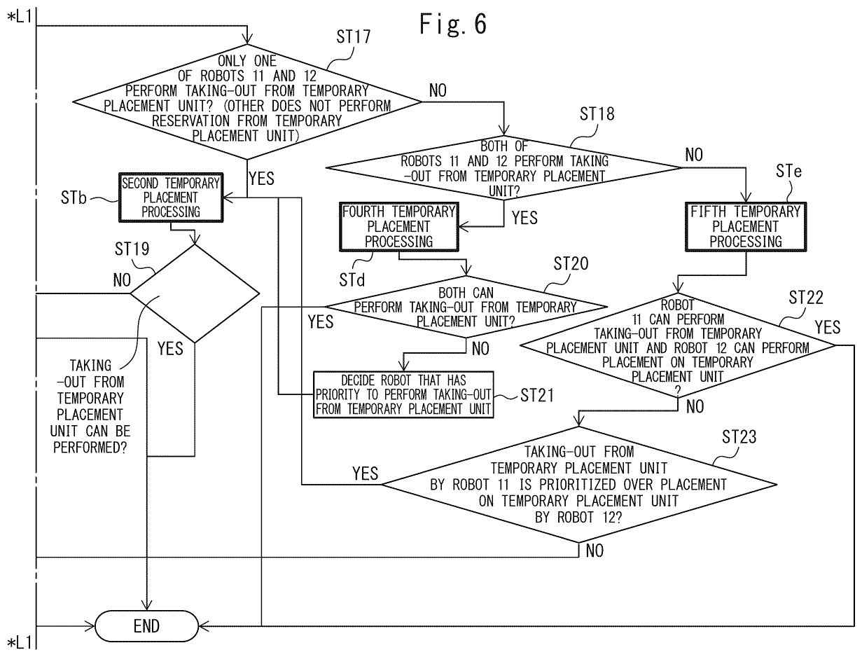

Note that the robot control program according to the present embodiment described above is executed by, for example, the robot controller (arithmetic processing device) 2 that controls each of the robots 1. For example, as described above, control information about the temporary placement unit that is generated by execution by each of the robot controllers 2 and is generated by each of the temporary placement unit control information-generation units 22 is output to the external temporary placement unit control device 9 such as the PLC being the host control device of the plurality of robot controllers 2. Furthermore, as described with reference to FIGS. 5 and 6 next, there may be a case where the article 4 cannot be actually reserved (taken out and temporarily placed) on the temporary placement unit and a case where both of the robots (11, 12) are to perform reservation on the temporary placement unit but only one of the robots can perform reservation, according to a situation of the temporary placement conveyor 8 (temporary placement unit), for example.

FIGS. 5 and 6 are flowcharts for describing one example of temporary placement unit control processing in the one example of the robot system according to the present embodiment. As illustrated in FIGS. 5 and 6, when the one example of the temporary placement unit control processing in the one example of the robot system according to the present embodiment starts, whether only one of the robots 11 and 12 performs placement on the temporary placement unit, i.e., whether the other does not perform reservation from the temporary placement unit is determined in step ST11.

In step ST11, when it is determined that only one of the robots 11 and 12 places the article 4 on the temporary placement unit (YES), the processing proceeds to step STa, first temporary placement processing is executed, and the processing further proceeds to step ST13. In step ST11, when it is determined that only one of the robots 11 and 12 does not place the article 4 on the temporary placement unit (NO), the processing proceeds to step ST12, and whether both of the robots 11 and 12 perform placement on the temporary placement unit is determined.

In step ST12, when it is determined that both of the robots 11 and 12 place the article 4 on the temporary placement unit (YES), the processing proceeds to step STc, third temporary placement processing is executed, and the processing further proceeds to step ST14. In step ST12, when it is determined that both of the robots 11 and 12 do not place the article 4 on the temporary placement unit (NO), the processing proceeds to step ST17, and whether only one of the robots 11 and 12 performs taking-out from the temporary placement unit, i.e., whether the other does not perform reservation from the temporary placement unit is determined.

In step ST17, when it is determined that only one of the robots 11 and 12 takes out the article 4 from the temporary placement unit (YES), the processing proceeds to step STb, second temporary placement processing is executed, and the processing further proceeds to step ST19. In step ST17, when it is determined that only one of the robots 11 and 12 does not take out the article 4 from the temporary placement unit (NO), the processing proceeds to step ST18, and whether both of the robots 11 and 12 perform taking-out from the temporary placement unit is determined.

In step ST18, when it is determined that both of the robots 11 and 12 take out the article 4 from the temporary placement unit (YES), the processing proceeds to step STd, fourth temporary placement processing is executed, and the processing further proceeds to step ST20. In step ST18, when it is determined that both of the robots 11 and 12 do not take out the article 4 from the temporary placement unit (NO), the processing proceeds to step STe, fifth temporary placement processing is executed, and the processing further proceeds to step ST22.

In step ST13, whether placement on the temporary placement unit can be performed is determined. In step ST13, when it is determined that the article 4 cannot be placed on the temporary placement unit (NO), the processing proceeds to step ST16, and the processing ends without reserving the article 4 from the temporary placement unit. In step ST13, when it is determined that the article 4 can be placed on the temporary placement unit (YES), the processing ends without any change. Note that FIGS. 5 and 6 illustrate the control processing of the temporary placement unit, and, when it is determined that the article 4 can be placed on the temporary placement unit (YES) in step ST13, one of the robots 11 and 12 places the article 4 on the temporary placement unit (temporary placement conveyor 8), for example.

In step ST14, whether both can perform placement on the temporary placement unit is determined, and, when it is determined that both of the robots 11 and 12 can place the article 4 on the temporary placement unit (YES), the processing ends without any change. In step ST14, when it is determined that both of the robots 11 and 12 cannot place the article 4 on the temporary placement unit (NO), the processing proceeds to step ST16, and the processing ends without reserving the article 4 from the temporary placement unit.

In step ST19, whether taking-out from the temporary placement unit can be performed is determined, and, when it is determined that the article 4 can be taken out from the temporary placement unit (YES), the processing ends without any change. In step ST19, when it is determined that the article 4 cannot be taken out from the temporary placement unit (NO), the processing proceeds to step ST16, and the processing ends without reserving the article 4 from the temporary placement unit.

In step ST20, whether both can perform taking-out from the temporary placement unit is determined, and, when it is determined that both of the robots 11 and 12 can take out the article 4 from the temporary placement unit (YES), the processing ends without any change. In step ST20, when it is determined that both of the robots 11 and 12 cannot take out the article 4 from the temporary placement unit (NO), the processing proceeds to step ST21, a robot that has priority to take out the article 4 from the temporary placement unit is decided, the processing proceeds to step STb, the second temporary placement processing is executed, and the processing further proceeds to step ST19.

In step ST22, whether the robot 11 can perform taking-out from the temporary placement unit and the robot 12 can perform placement on the temporary placement unit is determined. In step ST22, when it is determined that the robot 11 can take out the article 4 from the temporary placement unit and the robot 12 can place the article 4 on the temporary placement unit (YES), the processing ends without any change. In step ST22, when it is determined that the robot 11 cannot take out the article 4 from the temporary placement unit and the robot 12 cannot place the article 4 on the temporary placement unit (NO), the processing proceeds to step ST23.

In step ST23, whether taking-out from the temporary placement unit by the robot 11 is prioritized over placement (temporary placement) on the temporary placement unit by the robot 12 is determined. In step ST23, when it is determined that taking-out of the article 4 from the temporary placement unit by the robot 11 is prioritized over temporary placement of the article 4 on the temporary placement unit by the robot 12 (YES), the processing proceeds to step STb, the second temporary placement processing is executed, and the processing further proceeds to step ST19. In step ST23, when it is determined that taking-out of the article 4 from the temporary placement unit by the robot 11 is not prioritized over temporary placement of the article 4 on the temporary placement unit by the robot 12 (NO), the processing proceeds to step STa, the first temporary placement processing is executed, and the processing proceeds to step ST13.

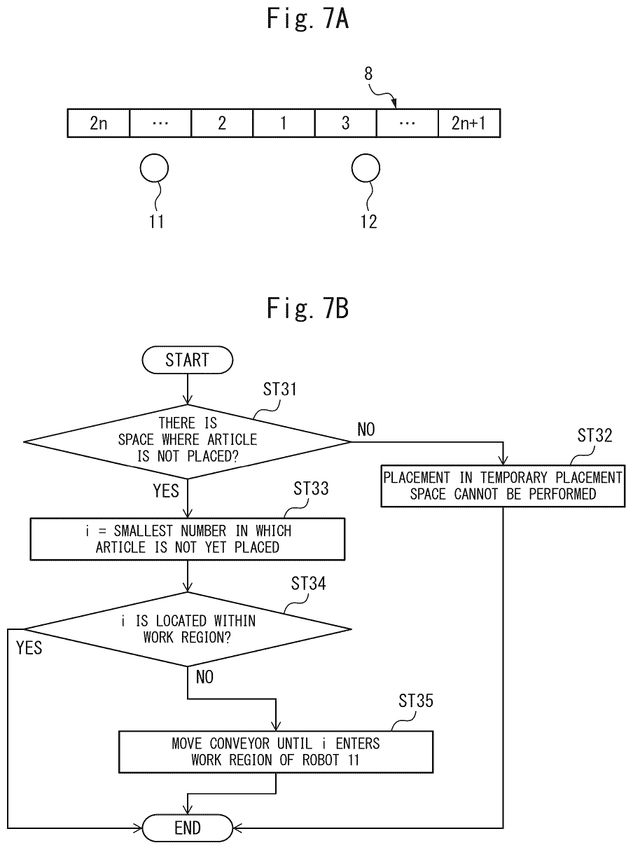

Next, the first temporary placement processing to the fifth temporary placement processing indicated in steps STa to STe in the flowcharts illustrated in FIGS. 5 and 6 will be described in detail with reference to FIGS. 7 to 11. In the following description, in order to simplify the description, temporary placement spaces on the temporary placement conveyor 8 are arranged in one line with respect to a movement direction (motion direction) of the temporary placement conveyor 8. As illustrated in FIG. 1 described above, movement by the temporary placement conveyor 8 can be achieved in such a way that, for example, the temporary placement space (temporary placement conveyor 8) on a most upstream side in a conveyance direction of the container conveyance conveyor 5 and the article conveyance conveyor 6 enters the work region A1 of the robot 11, and the temporary placement space on a most downstream side in the conveyance direction enters the work region A2 of the robot 12. In other words, when the article 4 is taken out from the temporary placement conveyor 8 (temporary placement space), the article 4 placed (temporarily placed) first as much as possible can be taken out.

Herein, specific control of the temporary placement conveyor 8 is as described below, for example. First, a known conventional technique (for example, a technique similar to that indicated as [PTL 1] in [CITATION LIST]) can be applied to judgment whether the robot 1 places the article 4 in the temporary placement space (temporary placement conveyor 8) or takes out the article 4 from the temporary placement space. For example, a time at which the robot 11 places the article 4 in the temporary placement space is recorded in the robot controller that controls the robot 11, and is also notified to the robot controller of the other robot 12 and the time is recorded. Note that it is needless to say that the specific control of the temporary placement conveyor 8 is not limited to processing described below, and can be appropriately modified or changed.

FIG. 7 is a diagram for describing one example of the first temporary placement processing in the flowcharts illustrated in FIGS. 5 and 6, and illustrates the processing when only one (robot 11) of the robots 11 and 12 places the article 4 in the temporary placement space and the other (robot 12) does not perform taking-out (reservation) from the temporary placement space. Herein, FIG. 7A illustrates a movement order of the temporary placement conveyor 8 (temporary placement space), and FIG. 7B illustrates a flowchart for describing the one example of the first temporary placement processing (STa). Herein, as illustrated in FIG. 7A, a number is assumed to be provided in such a way that, as a distance from the center “1” is greater, a numerical value increases, i.e., “2”, “3”, . . . , “2n”, and “2n+1”.

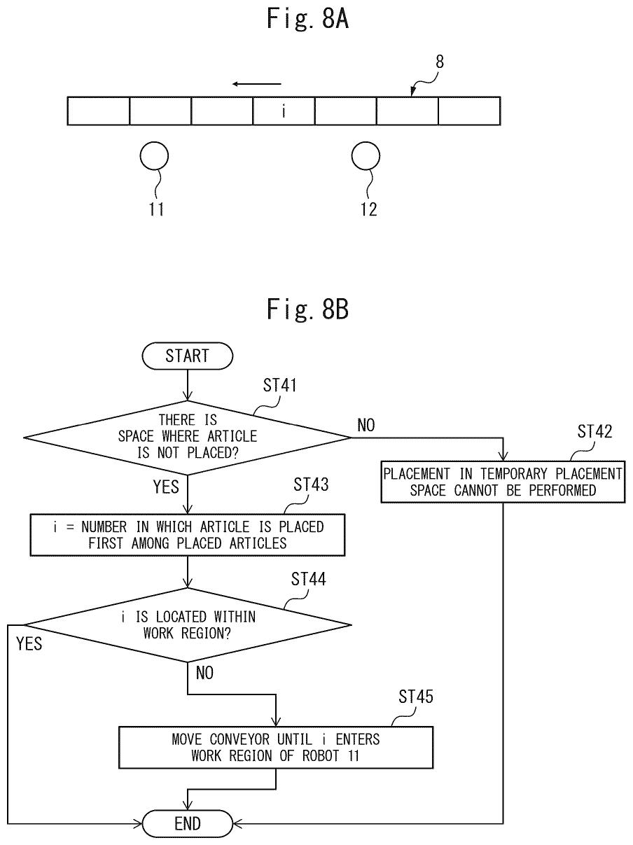

Furthermore, the temporary placement conveyor 8 does nothing when, for example, both of the robots 11 and 12 do not perform reservation from the temporary placement space. When only one of the robots 11 and 12 perform reservation from the temporary placement space, a position in which the article 4 is reserved is preferably set at the center of the temporary placement space as much as possible. In other words, for example, in order to avoid the temporary placement space located in front of the other robot 12 as much as possible when the robot 11 takes out the article 4 from the temporary placement conveyor 8, the temporary placement conveyor 8 is preferably moved in such a way that the article 4 taken out by the robot 11 is the article 4 placed first among the articles 4 placed in the current temporary placement space. This is also similar in the second temporary placement processing described with reference to FIG. 8.

As illustrated in FIG. 7B, when the one example of the first temporary placement processing (STa) starts, whether there is a space where the article 4 is not placed is determined in step ST31, and, when it is determined that there is no space where the article 4 is not placed (NO), the processing proceeds to step ST32, and the processing ends by assuming that placement in the temporary placement space cannot be performed. In step ST31, when it is determined that there is the space where the article 4 is not placed (YES), the processing proceeds to step ST33, and the processing proceeds to step ST34 by assuming that i=a smallest number in which the article 4 is not yet placed.

In step ST34, whether i is located within a work region is determined, and, for example, when it is determined that i is located within the work region A1 of the robot 11 (YES), the processing ends without any change, and, when it is determined that i is not located within the work region A1 of the robot 11 (NO), the processing proceeds to step ST35, the temporary placement conveyor 8 is moved until i enters the work region A1 of the robot 11, and then the processing ends. Note that, as described above, similarly to FIGS. 5 and 6, the one example of the first temporary placement processing illustrated in FIG. 7B illustrates the control processing of the temporary placement unit. When it is determined that i is located within the work region (YES) in step ST34 and when the temporary placement conveyor 8 is moved until i enters the work region A1 of the robot 11 in step ST35, for example, the robot 11 places the article 4 on the temporary placement conveyor 8 (temporary placement space) in the work region A1 of the robot 11. When it is determined that there is no space where the article 4 is not placed (NO) in step ST31, the processing proceeds to step ST32, and placement in the temporary placement space cannot be performed, for example, the robot 11 recognizes that the article 4 cannot be temporarily placed in the temporary placement space and does not perform temporary placement of the article 4.

FIG. 8 is a diagram for describing one example of the second temporary placement processing in the flowcharts illustrated in FIGS. 5 and 6. Herein, FIG. 8A illustrates a movement order of the temporary placement space, and FIG. 8B illustrates a flowchart for describing the one example of the second temporary placement processing (STb). As illustrated in FIG. 8A, the temporary placement space (temporary placement conveyor 8) moves in a direction from the left to the right (direction from the robot 12 toward the robot 11) in the diagram.

As illustrated in FIG. 8B, when the one example of the second temporary placement processing (STb) starts, whether there is a space where the article 4 is not placed is determined in step ST41, and, when it is determined that there is no space where the article 4 is not placed (NO), the processing proceeds to step ST42, and the processing ends by assuming that placement in the temporary placement space cannot be performed. In step ST41, when it is determined that there is the space where the article 4 is not placed (YES), the processing proceeds to step ST43, and the processing proceeds to step ST44 by assuming that i=a number in which the article 4 is placed first among the placed articles 4.

In step ST44, whether i is located within a work region is determined, and, for example, when it is determined that i is located within the work region Al of the robot 11 (YES), the processing ends without any change, and, when it is determined that i is not located within the work region A1 of the robot 11 (NO), the processing proceeds to step ST45, the temporary placement conveyor 8 is moved until i enters the work region A1 of the robot 11, and then the processing ends.

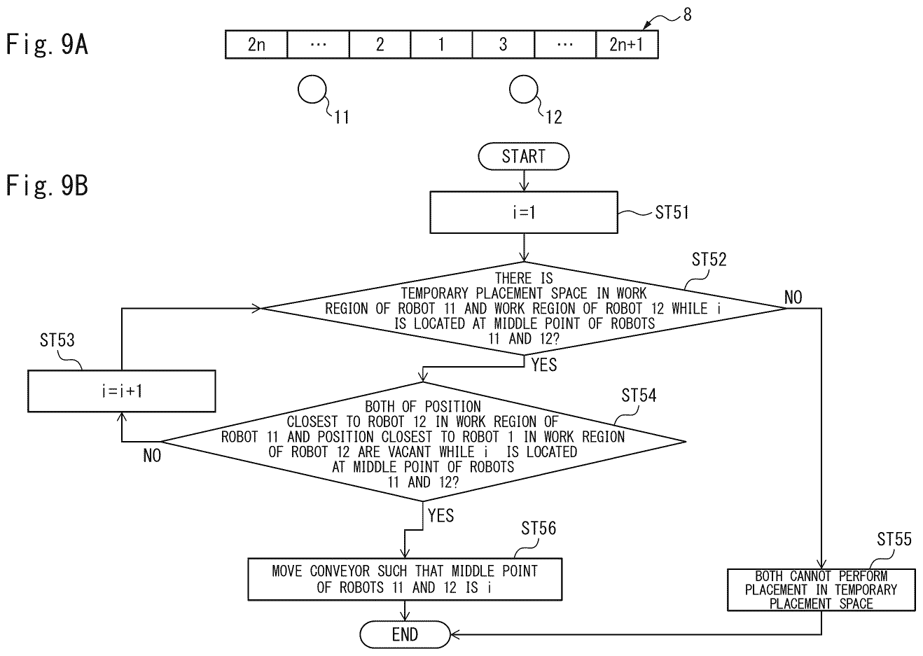

FIG. 9 is a diagram for describing one example of the third temporary placement processing in the flowcharts illustrated in FIGS. 5 and 6, and is used for describing a case where the two robots 11 and 12 simultaneously execute processing. Herein, FIG. 9A illustrates a movement order of the temporary placement space, and FIG. 9B illustrates a flowchart for describing the one example of the third temporary placement processing (STc). Note that FIG. 9A is similar to FIG. 7A described above.

As illustrated in FIG. 9B, when the one example of the third temporary placement processing (STc) starts, it is assumed that i=1 in step ST51, and the processing proceeds to ST52, and whether there is the temporary placement space in the work region A1 of the robot 11 and the work region A2 of the robot 12 while i is located at a middle point of the robots 11 and 12 is determined. In step ST52, when it is determined that there is no temporary placement space in the work regions A1 and A2 while i is located at the middle point of the robots 11 and 12 (NO), the processing proceeds to step ST55, and the processing ends by assuming that both of the robots 11 and 12 cannot place the article 4 in the temporary placement space.

In step ST52, when it is determined that there is the temporary placement space in the work regions A1 and A2 while i is located at the middle point of the robots 11 and 12 (YES), the processing proceeds to step ST54, and whether both of a position closest to the robot 12 in the work region A1 of the robot 11 and a position closest to the robot 11 in the work region A2 of the robot 12 are vacant while i is located at the middle point of the robots 11 and 12 is determined. In step ST54, when it is determined that both of the position closest to the robot 12 in the work region A1 of the robot 11 and the position closest to the robot 11 in the work region A2 of the robot 12 are vacant while i is located at the middle point of the robots 11 and 12 (YES), the processing proceeds to step ST56, the temporary placement conveyor 8 is moved in such a way that the middle point of the robots 11 and 12 is i, and the processing ends. In this way, when both of the robots 11 and 12 place the article 4 in the temporary placement space, the temporary placement conveyor 8 is preferably moved in such a way that a space farther from the center in the space where the article 4 is placed is as close to the center as possible.

Note that, similarly to the description above, for example, when both of the robots 11 and 12 cannot place the article 4 in the temporary placement space in step ST55, both of the robots 11 and 12 recognize that the article 4 cannot be placed in the temporary placement space and do not place the article 4 in the temporary placement space. When the temporary placement conveyor 8 is moved in such a way that the middle point of the robots 11 and 12 is i in step ST56, both of the robots 11 and 12 recognize that the article 4 can be placed in the temporary placement space and each place the article 4 in the temporary placement space.

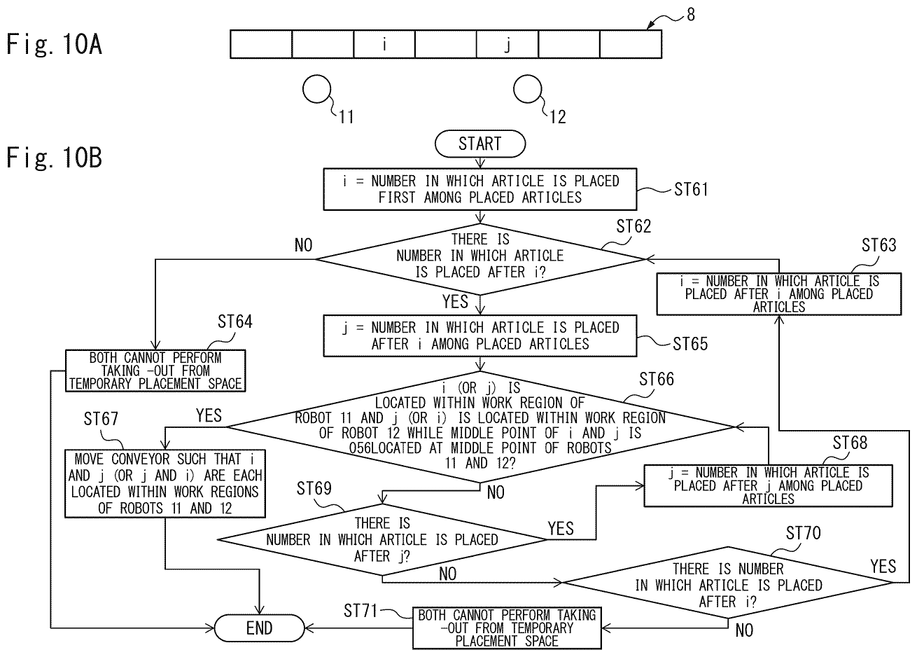

FIG. 10 is a diagram for describing one example of the fourth temporary placement processing in the flowcharts illustrated in FIGS. 5 and 6. Herein, FIG. 10A illustrates a movement order of the temporary placement space, and FIG. 10B illustrates a flowchart for describing the one example of the fourth temporary placement processing (STd). As illustrated in FIG. 10A, temporary placement spaces i and j with respect to the robots 11 and 12 are set.

As illustrated in FIG. 10B, when the one example of the fourth temporary placement processing starts, it is assumed that i =a number in which the article 4 is placed first among the placed articles 4 in step ST61, the processing proceeds to step ST62, and whether there is a number in which the article 4 is placed after i is determined. In step ST62, when it is determined that there is no number in which the article 4 is placed after i (NO), the processing proceeds to step ST64, and the processing ends by assuming that both of the robots 11 and 12 cannot take out the article 4 from the temporary placement space. In step ST62, when it is determined that there is the number in which the article 4 is placed after i (YES), the processing proceeds to step ST65, and the processing proceeds to step ST66 by assuming that j=a number in which the article 4 is placed after i among the placed articles 4.

In step ST66, whether i (or j) is located within the work region A1 of the robot 11 and j (or i) is located within the work region A2 of the robot 12 while a middle point of i and j is located at the middle point of the robots 11 and 12 is determined. In step ST66, when it is determined that i (or j) is located within the work region A1 of the robot 11 and j (or i) is located within the work region A2 of the robot 12 while the middle point of i and j is located at the middle point of the robots 11 and 12 (YES), the processing proceeds to step ST67, the temporary placement conveyor 8 is moved in such a way that i and j (or j and i) are each located within the work regions A1 and A2 of the robots 11 and 12, and the processing ends. In step ST66, when it is determined that i (or j) is not located within the work region A1 of the robot 11 and j (or i) is not located within the work region A2 of the robot 12 while the middle point of i and j is located at the middle point of the robots 11 and 12 (NO), the processing proceeds to step ST69, and whether there is a number in which the article 4 is placed after j is determined.

In step ST69, when it is determined that there is the number in which the article 4 is placed after j (YES), the processing proceeds to step ST68, and the processing returns to step ST66 by assuming that j=a number in which the article 4 is placed after i among the placed articles 4. In step ST69, when it is determined that there is no number in which the article 4 is placed after j (NO), the processing proceeds to step ST70, and whether there is a number in which the article 4 is placed after i is determined. In step ST70, when it is determined that there is the number in which the article 4 is placed after i (YES), the processing proceeds to step ST63, and the processing returns to step ST62 by assuming that i=a number in which the article 4 is placed after i among the placed articles 4. In step ST70, when it is determined that there is no number in which the article 4 is placed after i (NO), the processing proceeds to step ST71, and the processing ends by assuming that both of the robots 11 and 12 cannot take out the article 4 from the temporary placement space.

In this way, when both of the robots 11 and 12 take out the article 4 from the temporary placement space, the temporary placement conveyor 8 is preferably moved in such a way that one robot 11 takes out the article 4 placed first as much as possible and the other robot 12 takes out the article 4 placed next as much as possible while a condition that there are the articles 4 temporarily placed in the work regions A1 and A2 of both of the robots 11 and 12 is satisfied.

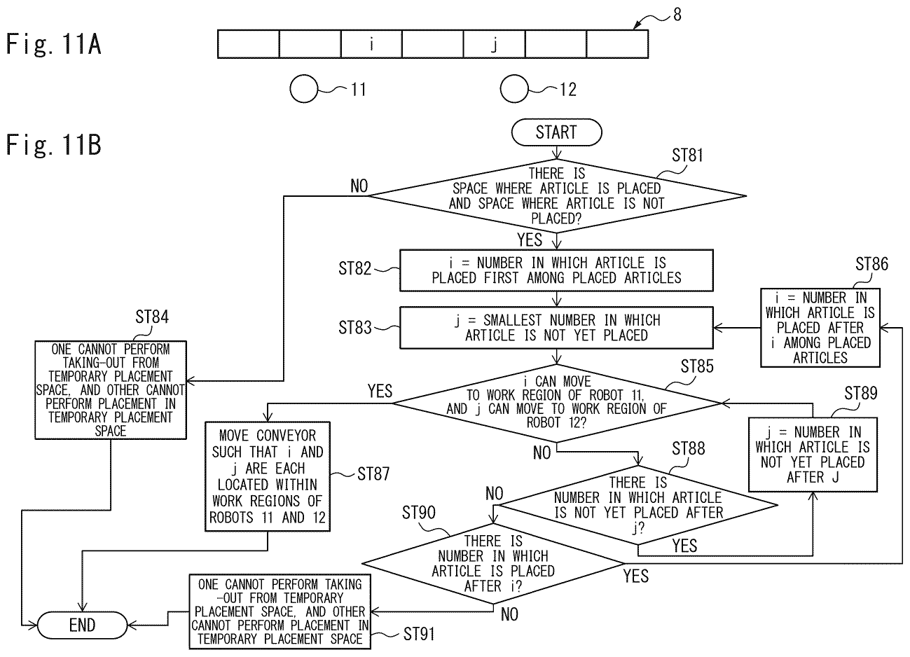

FIG. 11 is a diagram for describing one example of the fifth temporary placement processing in the flowcharts illustrated in FIGS. 5 and 6, and illustrates a case where either one (for example, the robot 11) of the robots 11 and 12 takes out the article 4 from the temporary placement space and the other (for example, the robot 12) places the article 4 in the temporary placement space. Herein, FIG. 11A illustrates a movement order of the temporary placement space, and FIG. 11B illustrates a flowchart for describing the one example of the fifth temporary placement processing (STe. Note that FIG. 11A is similar to FIG. 10A described above.

As illustrated in FIG. 11B, when the one example of the fifth temporary placement processing starts, whether there is the temporary placement space where the article 4 is placed and the temporary placement space where the article 4 is not placed is determined in step ST81. In step ST81, when it is determined that there is the temporary placement space where the article 4 is placed and the temporary placement space where the article 4 is not placed (YES), the processing proceeds to step ST82, and the processing proceeds to step ST83 by assuming that i=a number in which the article 4 is placed first among the placed articles 4. In step ST81, when it is determined that there is no temporary placement space where the article 4 is placed and no temporary placement space where the article 4 is not placed (NO), the processing proceeds to step ST84, and the processing ends by assuming that one robot 11 cannot take out the article 4 from the temporary placement space and the other robot 12 cannot place the article in the temporary placement space.

In step ST83, it is assumed that j =a smallest number in which the article 4 is not yet placed, and the processing proceeds to step ST85. In step ST85, whether i can move to the work region A1 of the robot 11 and j can move to the work region A2 of the robot 12 is determined. In step ST85, whether i can move to the work region A1 of the robot 11 and j can move to the work region A2 of the robot 12 is determined. In step ST85, when it is determined that i can move to the work region A1 of the robot 11 and j can move to the work region A2 of the robot 12 (YES), the processing proceeds to step ST87, the temporary placement conveyor 8 is moved in such a way that i and j are each located within the work regions A1 and A2 of the robots 11 and 12, and the processing ends. In step ST85, when it is determined that i cannot move to the work region A1 of the robot 11 and j cannot move to the work region A2 of the robot 12 (NO), the processing proceeds to step ST88, and whether there is a number in which the article 4 is not yet placed after j is determined.

In step ST88, when it is determined that there is the number in which the article 4 is not yet placed after j (YES), the processing proceeds to step ST89, and the processing returns to step ST85 by assuming that i=a number in which the article 4 is not yet placed after j. In step ST88, when it is determined that there is no number in which the article 4 is not yet placed after j (NO), the processing proceeds to step ST90, and whether there is a number in which the article 4 is placed after i is determined. In step ST90, when it is determined that there is the number in which the article 4 is placed after i (YES), the processing proceeds to step ST86, and the processing returns to step ST83 by assuming that i=a number in which the article 4 is placed after i among the placed articles 4. In step ST90, when it is determined that there is no number in which the article 4 is placed after i (NO), the processing proceeds to step ST91, and the processing ends by assuming that one robot 11 cannot take out the article 4 from the temporary placement space and the other robot 12 cannot place the article 4 in the temporary placement space.

In this way, when either one (for example, the robot 11) of the robots 11 and 12 takes out the article 4 from the temporary placement space, and the other (for example, the robot 12) places the article 4 in the temporary placement space, the temporary placement conveyor 8 is preferably moved in such a way that the robot 11 takes out the article 4 placed first as much as possible while a condition that there is a vacant temporary placement space in the work region A2 of the robot 12 is satisfied.

As described with reference to FIG. 4, the robot control program according to the present embodiment can be executed by, for example, the robot controller (arithmetic processing device) 2 that controls each of the robots 1. As described with reference to FIGS. 5 to 11, the temporary placement unit control processing (temporary placement unit control program) in the one example of the robot system according to the present embodiment can be executed by, for example, the temporary placement unit control device (arithmetic processing device) 9 provided in the programmable logic controller being the host control device of the plurality of robot controllers 2 that control the plurality of robots 1. Note that the temporary placement unit control processing described with reference to FIGS. 5 to 11 is merely an example, and a movement direction and a movement amount of the temporary placement conveyor 8 that can move in both directions are controlled based on various conditions for actually a greater number of robots.

The robot control program and the temporary placement unit control program may be recorded in a computer-readable non-transitory recording medium and a non-volatile semiconductor memory and be provided, and may be provided via a wired manner or a wireless manner. Herein, as the computer-readable non-transitory recording medium, for example, an optical disc such as a compact disc read only memory (CD-ROM) and a DVD-ROM, a hard disc device, or the like is conceivable. Further, as the non-volatile semiconductor memory, a programmable read only memory (PROM), a flash memory, and the like are conceivable. Furthermore, as distribution from a server device, provision via a local area network (LAN) in a wired manner or a wireless manner or via a wide area network (WAN) such as the Internet is conceivable.

As described above in detail, the robot controller, the robot system, and the robot control program according to the present embodiment can effectively use a temporary placement unit onto which an oversupplied excessive article is withdrawn.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can also be executed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the above-described embodiments and variations, the following descriptions are further disclosed.

### APPENDIX 1

A robot controller (2) that controls a robot (1) in such a way that the robot (1) takes out an article (4) conveyed by an article conveyance device (6) while following the article (4), and packs the article (4) in a container (3) conveyed by a container conveyance device (5) while following the container (3), the robot controller including:
a container supply amount calculation unit (23) that calculates a supply amount of a plurality of the containers (3) conveyed by the container conveyance device (5);
an article supply amount calculation unit (21) that calculates a supply amount of a plurality of the articles (4) conveyed by the article conveyance device (6); and
a temporary placement unit control information-generation unit (22) that generates control information about a temporary placement unit (8) including a temporary placement space where at least one of the articles (4) is temporarily placed and being movable by a predetermined amount in a first direction or a second direction opposite to the first direction, based on an output of the container supply amount calculation unit (23) and an output of the article supply amount calculation unit (21)

### APPENDIX 2

The robot controller according to appendix 1, wherein
the container supply amount calculation unit (23) further calculates a current position of the container (3) conveyed by the container conveyance device (5), and
the article supply amount calculation unit (21) further calculates a current position of each of the articles (4) conveyed by the article conveyance device (6).

### APPENDIX 3

The robot controller according to appendix 1 or 2, wherein
the temporary placement unit (8) is a temporary placement conveyor in which movement in the first direction and the second direction is controllable.

### APPENDIX 4

The robot controller according to appendix 3, wherein
the temporary placement conveyor (8) is disposed across at least two work regions (A1, A2) of at least two robots (11, 12).

### APPENDIX 5

The robot controller according to appendix 3 or 4, wherein
the container conveyance device (5) is a container conveyance conveyor configured to move the plurality of containers (3) in the first direction, and
the article conveyance device (6) is an article conveyance conveyor configured to move the plurality of articles (4) in the first direction.

### APPENDIX 6

The robot controller according to appendix 5, wherein
the temporary placement conveyor (8), the container conveyance conveyor (5), and the article conveyance conveyor (6) are each a line conveyor disposed in parallel.

### APPENDIX 7

The robot controller according to any one of appendixes 1 to 6, wherein
the container supply amount calculation unit (23) receives an output of a position information acquisition sensor (51) that is provided on the container conveyance device (5) and acquires position information about the container (4) to be conveyed, and an output of a first encoder (50) that detects a movement amount of the container (4) to be conveyed, and
the article supply amount calculation unit (21) receives an output of a camera (61) that is provided on the article conveyance device (6) and captures a state of the article (4) to be conveyed, and an output of a second encoder (60) that detects a movement amount of the article (4) to be conveyed.

### APPENDIX 8

The robot controller according to any one of appendixes 1 to 7, wherein
the temporary placement unit control information-generation unit (22) receives an output of the container supply amount calculation unit (23) and an output of the article supply amount calculation unit (21), and also an output of a third encoder (80) that detects a movement amount and a movement direction of the article (4) temporarily placed in the temporary placement space.

### APPENDIX 9

The robot controller according to any one of appendixes 1 to 8, wherein
the control information about the temporary placement unit (8) being generated by the temporary placement unit control information-generation unit (22) is output to an external temporary placement unit control device (9) that controls the temporary placement unit (8).

### APPENDIX 10

The robot controller according to appendix 9, wherein
the temporary placement unit control device (9) is provided in a programmable logic controller that controls a plurality of robots (1) via a plurality of robot controllers (2) and is a host control device of the plurality of robot controllers (2).

### APPENDIX 11

A robot system including:
the plurality of robots (1);
the article conveyance device (6);
the container conveyance device (5);
the temporary placement unit (8); and
the plurality of robot controllers (2) according to any one of appendixes 1 to 10 that each control the plurality of robots (1).

### APPENDIX 12

A robot control program that controls a robot (1) in such a way that the robot (1) takes out an article (4) conveyed by an article conveyance device (6) while following the article (4), and packs the article (4) in a container (3) conveyed by a container conveyance device (5) while following the container (3), the robot control program causing an arithmetic processing device (2) to execute processing of:
calculating a supply amount of a plurality of the containers (3) conveyed by the container conveyance device (5);
calculating a supply amount of a plurality of the articles (4) conveyed by the article conveyance device (6); and
generating control information about a temporary placement unit including a temporary placement space where at least one of the articles (4) is temporarily placed and being movable by a predetermined amount in a first direction or a second direction opposite to the first direction, based on a calculated supply amount of the container (3) and a calculated supply amount of the article (4).

### REFERENCE SIGNS LIST

1,11,12 Robot
1a Arm
1b End Effector (Grasping Portion)
2 Robot Controller
3 Container
4 Article
5 Container Conveyance Conveyor (Container Conveyance Device)
6 Article Conveyance Conveyor (Article Conveyance Device)
8 Temporary Placement Conveyor (Temporary Placement Unit)
9 Temporary Placement Unit Control Device
21 Article Supply Amount Calculation Unit
22 Temporary Placement Unit Control Information-Generation Unit
23 Container Supply Amount Calculation Unit
50 Encoder (Encoder for Container Conveyance Conveyor: First Encoder)
51 Photoelectric Sensor (Position Information Acquisition Sensor)
51a Light Receiving Unit
51b Light Emitting Unit
60 Encoder (Encoder for Article Conveyance Conveyor: Second Encoder)
61 Camera
80 Encoder (Encoder for Temporary Placement Conveyor: Third Encoder)
100 Robot System
A1, A2 Work Region of Robot

1. A robot controller that controls a robot in such a way that the robot takes out an article conveyed by an article conveyance device while following the article, and packs the article in a container conveyed by a container conveyance device while following the container, the robot controller comprising:
a container supply amount calculation unit that calculates a supply amount of a plurality of the containers conveyed by the container conveyance device;
an article supply amount calculation unit that calculates a supply amount of a plurality of the articles conveyed by the article conveyance device; and
a temporary placement unit control information-generation unit that generates control information about a temporary placement unit including a temporary placement space where at least one of the articles is temporarily placed and being movable by a in a first direction or a second direction opposite to the first direction, based on an output of the container supply amount calculation unit and an output of the article supply amount calculation unit.

2. The robot controller according to claim 1, wherein
the container supply amount calculation unit further calculates a current position of the container conveyed by the container conveyance device, and
the article supply amount calculation unit further calculates a current position of each of the articles conveyed by the article conveyance device.

3. The robot controller according to claim 1, wherein
the temporary placement unit is a temporary placement conveyor in which movement in the first direction and the second direction is controllable.

4. The robot controller according to claim 3, wherein
the temporary placement conveyor is disposed across at least two work regions of at least two robots.

5. The robot controller according to claim 3, wherein
the container conveyance device is a container conveyance conveyor configured to move the plurality of containers in the first direction, and
the article conveyance device is an article conveyance conveyor configured to move the plurality of articles in the first direction.

6. The robot controller according to claim 5, wherein
the temporary placement conveyor, the container conveyance conveyor, and the article conveyance conveyor are each a line conveyor disposed in parallel.

7. The robot controller according to claim 1, wherein
the container supply amount calculation unit receives an output of a position information acquisition sensor that is provided on the container conveyance device and acquires position information about the container to be conveyed, and an output of a first encoder that detects a movement amount of the container to be conveyed, and
the article supply amount calculation unit receives an output of a camera that is provided on the article conveyance device and captures a state of the article to be conveyed, and an output of a second encoder that detects a movement amount of the article to be conveyed.

8. The robot controller according to claim 1, wherein
the temporary placement unit control information-generation unit receives an output of the container supply amount calculation unit and an output of the article supply amount calculation unit, and also an output of a third encoder that detects a movement amount and a movement direction of the article temporarily placed in the temporary placement space.

9. The robot controller according to claim 1, wherein
the control information about the temporary placement unit being generated by the temporary placement unit control information-generation unit is output to an external temporary placement unit control device that controls the temporary placement unit.

10. The robot controller according to claim 9, wherein
the temporary placement unit control device is provided in a programmable logic controller that controls a plurality of robots via a plurality of robot controllers and is a host control device of the plurality of robot controllers.

11. A robot system comprising:
the plurality of robots;
the article conveyance device;
the container conveyance device;
the temporary placement unit; and
the plurality of robot controllers according to claim 1 that each control the plurality of robots.

12. A computer readable non-transitory tangible medium for storing a robot control program that controls a robot in such a way that the robot takes out an article conveyed by an article conveyance device while following the article, and packs the article in a container conveyed by a container conveyance device while following the container, the robot control program causing an arithmetic processing device to execute processing of:
calculating a supply amount of a plurality of the containers conveyed by the container conveyance device;
calculating a supply amount of a plurality of the articles conveyed by the article conveyance device; and
generating control information about a temporary placement unit including a temporary placement space where at least one of the articles is temporarily placed and being movable in a first direction or a second direction opposite to the first direction, based on a calculated supply amount of the container and a calculated supply amount of the article.
